(19) United States
(12) Patent Application Publication
(10) Pub. No.: US 2007/0090737 A1
(43) Pub. Date: Apr. 26, 2007

(54) LIGHT-EMITTING DIODE ASSEMBLY AND METHOD OF FABRICATION

(75) Inventors: TSENG-HSIANG HU, Tu-Cheng,Taipei Hsien (TW); YIH-JONG HSIEH, Tu-Cheng,Taipei Hsien (TW); LI-KUANG TAN, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FOXCONN TECHNOLOGY CO., LTD., Tu-Cheng (TW)

(21) Appl. No.: 11/309,256

(22) Filed: Jul. 20, 2006

(30) Foreign Application Priority Data
Oct. 20, 2005 (CN) 200510100558.8

(51) Int. Cl. H01J 61/52; H01J 7/24; H01J 1/02

(52) U.S. Cl. 313/11; 362/800

(57) ABSTRACT

A light-emitting diode (LED) assembly and a method for fabrication thereof are disclosed. The LED assembly includes a heat-absorbing member in which a working fluid is provided, an LED die (60) directly attached to the heat-absorbing member, and a heat-dissipating member thermally attached to the heat-absorbing member. The heat-absorbing member absorbs heat via the working fluid from the LED die and transfers the heat to the heat-dissipating member for dissipation. The method involves directly attaching the LED die to the heat-absorbing member.

### FIELD OF THE INVENTION

The present invention relates generally to light-emitting diode (LED) assemblies, and more particularly to an LED assembly with improved heat dissipation ability so that heat generated by the LEDs of the assembly can be effectively removed. The present invention relates also to a method of packaging the LEDs.

### DESCRIPTION OF RELATED ART

Light-emitting diode (LED) is a highly efficient light source currently used widely in such field as automobile, screen display, and traffic light indication. When the LED operates to give off light, heat is accordingly produced. If not rapidly and efficiently removed, the heat produced may significantly reduce the lifespan of the LED.

FIG. 7 shows an LED module 10 mounted to a circuit board 18 in accordance with related art. The LED module 10 includes an LED die 11, a packaging layer 12, and a pair of conductive pins 14, 15. The LED die 11, which is placed in a recess defined in the conductive pin 15, is protectively packaged via the packaging layer 12. Heat produced by the LED die 11 during its operation is transferred by the conductive pin 15 to the circuit board 18 through which the heat is dissipated into ambient air. In this embodiment, heat dissipation efficiency for the LED die 11 is not satisfactory since the heat is conducted only through the conductive pin 15, and the circuit board 18 has a relatively low heat removal ability.

FIG. 8A and FIG. 8B show another kind of LED module 20 with improved heat conduction capability compared with the LED module 10 illustrated in FIG. 7. The LED module 20 includes an LED die 21, a packaging layer 22 and a metal block 23. Protected by the packaging layer 22, the LED die 21 is accommodated in a recess defined at a top portion of the metal block 23. The LED module 20 is mounted within a through hole 281 defined in a circuit board 28, and a bottom surface of the metal block 23 of the LED module 20 is maintained in thermal contact with a metal plate 29 placed under the circuit board 28, whereby heat generated by the LED die 21 is capable of being conducted via the metal block 23 to the metal plate 29 for dissipation. In this particular embodiment, the metal plate 29 functions as a heat dissipation device and the metal block 23 has a relatively large contacting surface with the metal plate 29, thus increasing the heat dissipation efficiency for the LED module 20. However, before being conducted to the metal plate 29, the heat generated by the LED die 21 has to travel a long distance through the metal block 23. Furthermore, if the heat transferred to the metal plate 29 is not dispersed entirely and rapidly over the metal plate 29, a hot spot may exist at the contacting surfaces between the metal block 23 and the metal plate 29.

As an energy-efficient light source, currently LED has a trend of substituting for the well-known fluorescent lamps for indoor lighting purpose. In order to increase the overall lighting brightness, a plurality of LEDs are often incorporated into a single lamp, in which case how to efficiently dissipate heat generated by these LEDs becomes a challenge.

Therefore, it is desirable to provide an LED assembly wherein one or more of the foregoing disadvantages may be overcome or at least alleviated.

### SUMMARY OF THE INVENTION

The present invention relates, in one aspect, to a light-emitting diode (LED) assembly. The LED assembly includes a heat-absorbing member in which a working fluid is provided, an LED die directly attached to the heat-absorbing member, and a heat-dissipating member thermally attached to the heat-absorbing member. The heat-absorbing member absorbs heat via the working fluid from the LED die and transfers the heat to the heat-dissipating member for dissipation.

The present invention relates, in another aspect, to a method of packaging a light-emitting diode (LED). The method includes steps of: (A) providing a heat-absorbing member wherein a working fluid is provided in the heat-absorbing member; (B) attaching an LED die directly to the heat-absorbing member; and (C) thermally attaching a heat-dissipating member to the heat-absorbing member.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is an isometric view of an LED assembly in accordance with a first embodiment of the present invention;

FIG. 2 is a cross-sectional view of the LED assembly of FIG. 1;

FIG. 3 is a cross-sectional view of an LED assembly in accordance with a second embodiment of the present invention;

FIG. 4 is a cross-sectional view of an LED assembly in accordance with a third embodiment of the present invention;

FIG. 5 is a cross-sectional view of an LED assembly in accordance with a fourth embodiment of the present invention;

FIG. 6 is an isometric view of an LED assembly in accordance with a fifth embodiment of the present invention;

FIG. 7 is a cross-sectional view of an LED module in accordance with related art;

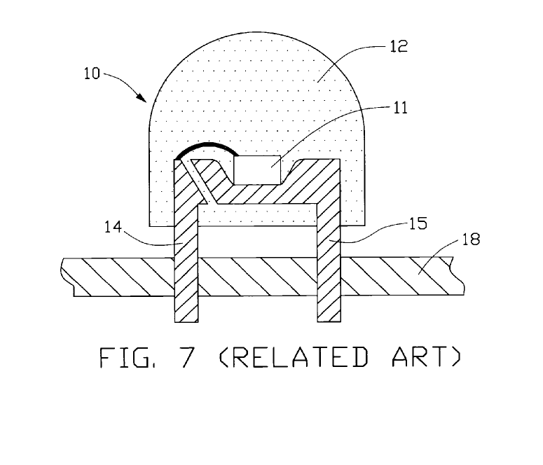

FIG. 8A is an isometric view of an LED assembly in accordance with related art; and

FIG. 8B is a cross-sectional view of the LED assembly of FIG. 8A.

### DETAILED DESCRIPTION OF THE INVENTION

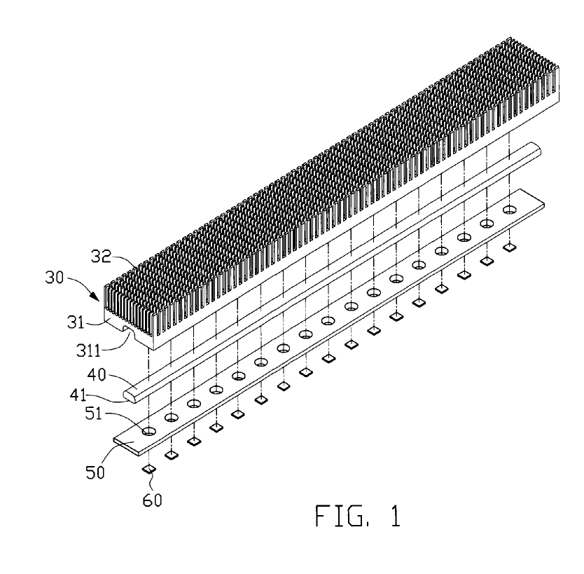

FIG. 1 illustrates an LED assembly in accordance with a first embodiment of the present invention. The LED assembly includes a heat sink 30, a heat pipe 40, a circuit board 50, and a plurality of LED dies 60.

The heat sink 30 is made of highly thermally conductive material such as copper, aluminum, or their alloys. The heat sink 30 as shown in this embodiment is an extruded aluminum heat sink, including a chassis 31 and a plurality of pin fins 32 extending upwardly from the chassis 31. The chassis 31 defines an elongated groove 311 at a bottom surface thereof for receiving the heat pipe 40 therein. The groove 311 has a substantially rectangular shape.

The heat pipe 40 is a heat transfer device having a relatively high heat transfer capability due to a phase change mechanism it adopts. The heat pipe 40 has the advantage of low thermal resistance and is capable of transferring a large amount of heat while maintaining a low temperature gradient between different sections thereof. In this particular embodiment, the heat pipe 40 has an elongated, substantially rectangular shaped configuration conforming to the shape of the groove 311 of the heat sink 30. The heat pipe 40 has a flat bottom surface 41. The heat pipe 40 is generally made of copper or copper alloy.

The circuit board 50 defines a plurality of through holes 51 for respectively receiving the LED dies 60 therein. The through holes 51 are arranged in a single row and are spaced from each other. The LED dies 60 are electrically mounted on the circuit board 50 via a plurality of wires (not labeled).

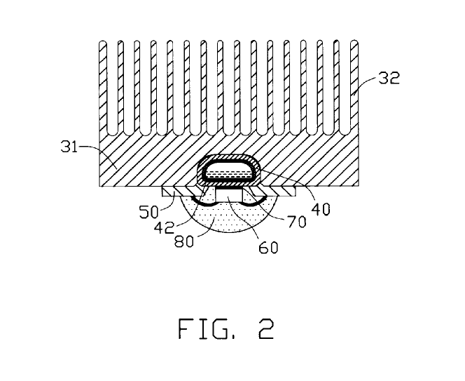

With reference to FIG. 2, in assembly, the heat pipe 40 is placed in the groove 311 of the heat sink 30, and is thermally and mechanically connected to the heat sink 30. Preferably, the heat pipe 40 is connected to the heat sink 30 via a layer of thermal interface material (TIM) such as thermal grease or tape. Alternatively, the heat pipe 40 is soldered to the heat sink 30 via a soldering material such as tin. The circuit board 50 is attached to the bottom surface of the chassis 31 of the heat sink 30 in such a manner that the through holes 51 in the circuit board 50 correspond to the flat bottom surface 41 of the heat pipe 40. A layer of dielectric material (not shown) such as a thin layer of rubber may be arranged between the heat sink 30 and the circuit board 50 so as to electrically insulate the circuit board 50 from the heat sink 30. The LED dies 60 are respectively received in the through holes 51 of the circuit board 50, and are maintained in thermal and physical contact with the bottom surface 41 of the heat pipe 40. Preferably, a thin layer of TIM 70 is arranged between the bottom surface 41 of the heat pipe 40 and a top surface (not labeled) of each of the LED dies 60. Each of the LED dies 60 is electrically connected to the circuit board 50 via a pair of wires (not labeled). In order to protect these LED dies 60, a packaging layer 80 is provided to encapsulate each of the LED dies 60. The packaging layer 80 is light penetrable and is generally made of polymeric material such as resin. The packaging layer 80 also functions to firmly secure the LED dies 60 in place.

In operation, the LED dies 60 give off light and at the same time generate a large amount of heat. The heat then is directly transferred to the heat pipe 40. As is best shown in FIG. 2, the heat pipe 40 has a hollow pipe body and contains a working fluid (not labeled) such as water therein. The heat pipe 40 generally is vacuumed. Against an inner surface of the pipe body is a wick structure 42, which is typically in the form of a plurality of fine grooves, a mesh screen or sintered powder, as is well known in the art by those skilled persons. As the heat is transferred to the heat pipe 40, the working fluid contained therein absorbs the heat and evaporates into vapor. Since the spreading resistance with regard to the vapor is negligible, the vapor which carries the heat then runs quickly to be full of an interior of the heat pipe 40, and whenever the vapor comes into contact with cooler walls (i.e., the top wall and the side walls) of the heat pipe 40, it releases the heat to the heat sink 30 which thermally contacts with the top and side walls. After the heat is released, the vapor condenses into liquid, which is then brought back by the wick structure 42 to the evaporating region, i.e., the contacting interface between the heat pipe 40 and each of the LED dies 60. Since the heat pipe 40 transfers the heat employing a phase change mechanism of the working fluid, the heat transferred to the heat pipe 40 from the LED dies 60 is thus rapidly and evenly distributed over the entire pipe body and then is further conveyed to the heat sink 30 through which the heat is dissipated into ambient air.

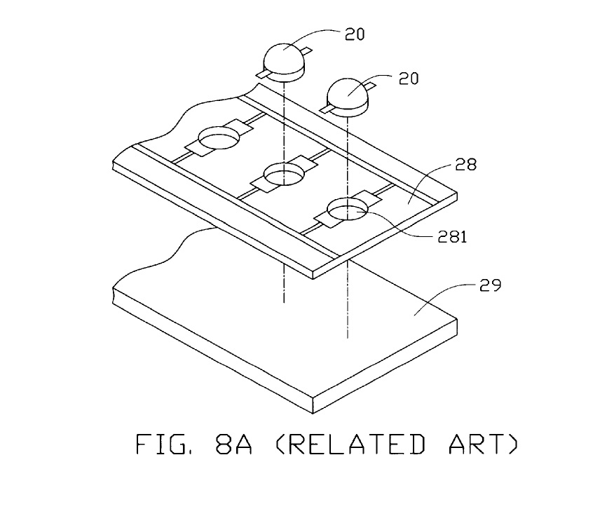

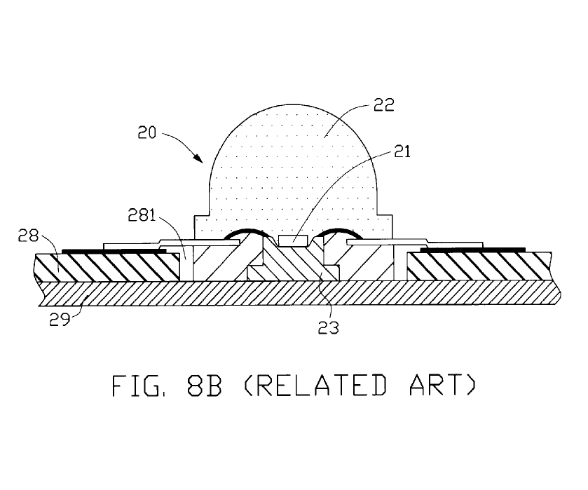

In the present LED assembly, the heat pipe 40 has a much higher heat transfer capability in comparison with the metal block 23 as shown in FIGS. 8A and 8B, which helps to conduct the heat from the LED dies 60 to the heat sink 30 more quickly. Furthermore, since the heat pipe 40 employs the working fluid to transfer the heat, the heat is capable of being distributed quickly throughout the heat pipe 40 and accordingly the heat sink 30, hot spot problem suffered by the related art is thus effectively avoided.

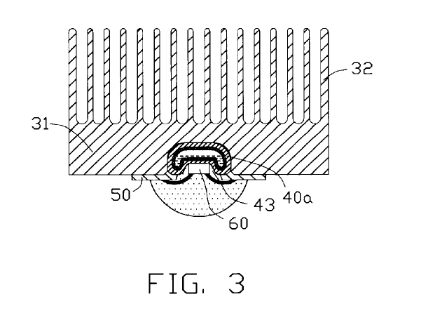

FIG. 3 illustrates a second embodiment of the present LED assembly, in which a plurality of recesses 43 are defined at the bottom surface 41 of the heat pipe 40a whereby the LED dies 60 are respectively received in the recesses 43 when they are mounted to the heat pipe 40a. Due to the presence of the recesses 43, the LED dies 60 and the heat pipe 40a are capable of being assembled in a more compact manner.

Apparently, in order to increase the heat dissipation efficiency for the LED assembly, multiple heat pipes 40 can be used. For example, two or more heat pipes 40 can be thermally attached to the chassis 31 of the heat sink 30.

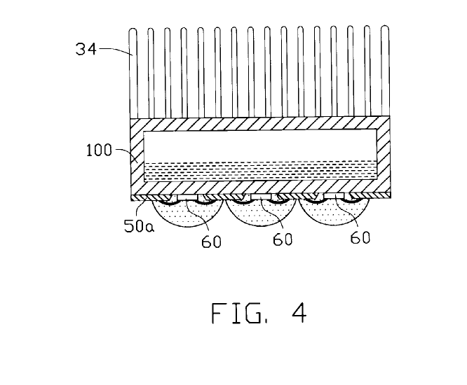

FIG. 4 illustrates a third embodiment of the present LED assembly, in which a vapor chamber-based heat spreader 100 is provided. The heat spreader 100 has a much larger size than the heat pipe 40 shown in the first embodiment. The heat spreader 100 has a top surface from which a plurality of fins 34 extend upwardly and a flat bottom surface to which a circuit board 50a is attached. In this embodiment, the circuit board 50a defines three rows of through holes 51 therein. The LED dies 60 are respectively located in the through holes 51 and are maintained in thermal and physical contact with the bottom surface of the heat spreader 100, either directly or through a layer of TIM. The heat spreader 100 contains a working fluid therein and also employs a phase change mechanism to transfer heat. The heat from the LED dies 60 is directly transferred to the heat spreader 100 and then is transferred from the heat spreader 100 to the fins 32 for dissipation. As with the heat pipe 40a shown in FIG. 3, the heat spreader 100 may also define a plurality of recesses at the bottom surface thereof for accommodating the LED dies 60 therein. In this embodiment, more LED dies 60 can be provided to the assembly so as to increase the overall lighting brightness.

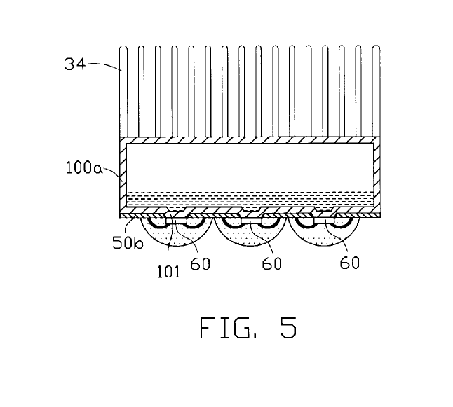

FIG. 5 illustrates a fourth embodiment of the present LED assembly, which is similar to the third embodiment shown in FIG. 4. However, the vapor chamber-based heat spreader 100a in this embodiment has a plurality of protrusions 101 extending outwardly from the bottom surface thereof. These protrusions 101 correspond to the through holes 51 defined in the circuit board 50b and are positioned in these through holes 51. The LED dies 60 are thermally and physically attached to these protrusions 101, either directly or by a layer of TIM. The presence of these protrusions 101 facilitates the positioning and securing of the circuit board 50b to the heat spreader 100a.

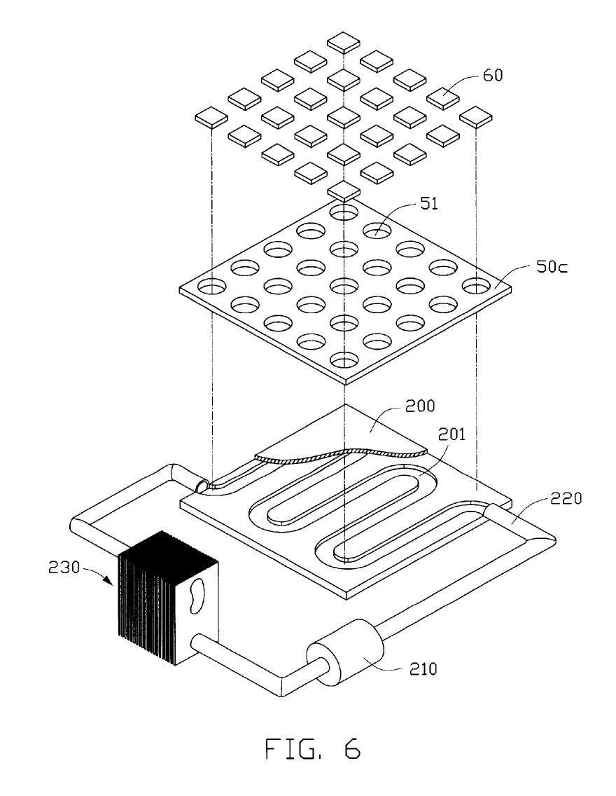

FIG. 6 shows a fifth embodiment of the present LED assembly. The LED assembly in this embodiment employs a liquid cooling system to dissipate the heat generated by the LED dies 60. The liquid cooling system includes a cold plate 200 through which a working fluid such as water (hereinafter as “coolant”) is circulated, a pump 210, a heat exchanger 230 and a plurality of connecting pipes 220. In this embodiment, the circuit board 50c defines a plurality of rows of through holes 51 therein. The cold plate 200 defines a flow channel 201 therein for passage of the coolant. The flow channel 201 is wave-shaped in order to increase heat exchange area between the coolant and the cold plate 200. The LED dies 60 are respectively received in the through holes 51 of the circuit board 50c and are maintained in thermal and mechanical contact with a top surface of the cold plate 200, either directly or via a layer of TIM. As the coolant passes through the flow channel 201, it receives the heat generated by the LED dies 60. The pump 210 drives the coolant to flow into the connecting pipe 220 through which the coolant is guided to the heat exchanger 230 where the heat carried in the coolant is released. Thereafter, the cooled coolant is sent back by the pump 210 to the cold plate 200 where it again available for absorbing heat from the LED dies 60.

According to the foregoing embodiments of the present LED assembly, the LED dies 60 are directly attached to the heat pipe 40 (40a), the vapor chamber-based heat spreader 100 (100a) or the cold plate 200. The heat pipe 40 (40a), the heat spreader 100 (100a) or the cold plate 200 functions as a heat-absorbing member directly absorbing the heat from these LED dies 60. Also, a working fluid is provided in the heat-absorbing member so as to effectively transfer the heat absorbed to a heat-dissipating member (i.e., the heat sink 30, the fins 34 or the heat exchanger 230) which is thermally connected with the heat-absorbing member. In particular, the heat is rapidly transferred from the heat-absorbing member to the heat-dissipating member for dissipation via a phase change mechanism or a rapid circulation of the working fluid in the heat-absorbing member, whereby the heat generated by the LED dies 60 is efficiently and effectively removed.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light-emitting diode (LED) assembly, comprising:
a heat-absorbing member in which a working fluid is provided;
an LED die directly attached to the heat-absorbing member; and
a heat-dissipating member thermally attached to the heat-absorbing member, the heat-absorbing member absorbing heat via the working fluid from the LED die and transferring the heat to the heat-dissipating member for dissipation.

2. The assembly of claim 1, wherein the heat-absorbing member includes a heat pipe having a flat surface to which the LED die is directly attached.

3. The assembly of claim 2, wherein the heat-dissipating member includes a heat sink, the heat sink defines a groove therein, the groove having a shape conforming to that of the heat pipe and receiving the heat pipe therein.

4. The assembly of claim 3, wherein the heat sink includes a chassis and a plurality of fins extending from a top surface of the chassis, the groove being defined at a bottom surface of the heat sink.

5. The assembly of claim 1, wherein the heat-absorbing member includes a vapor chamber-based heat spreader having a flat surface to which the LED die is directly attached.

6. The assembly of claim 5, wherein the heat-dissipating member includes a plurality of fins thermally attached to a surface of the heat spreader opposite to said flat surface.

7. The assembly of claim 1, wherein the heat-absorbing member includes a cold plate in which a flow channel is defined for passage of the working fluid.

8. The assembly of claim 7, wherein the heat-dissipating member includes a heat exchanger, the heat exchanger being fluidically connected to the flow channel via a plurality of connecting pipes, the working fluid being circulated between the cold plate and the heat exchanger.

9. The assembly of claim 1, wherein the heat-absorbing member defines a recess therein, the recess accommodating the LED die therein.

10. The assembly of claim 1, further comprising a circuit board, the circuit board defining a through hole therein, the LED die being placed in the through hole.

11. The assembly of claim 10, wherein the heat-absorbing member has a protrusion thereon, the protrusion being positioned in the through hole of the circuit board.

12. A method of packaging a light-emitting diode (LED), comprising:
providing a heat-absorbing member wherein a working fluid is provided in the heat-absorbing member;
attaching an LED die directly to the heat-absorbing member; and
thermally attaching a heat-dissipating member to the heat-absorbing member.

13. The method of claim 12, wherein the heat-absorbing member includes a heat pipe to which the LED die is directly attached, the heat-dissipating member includes a heat sink, and the heat sink defines a groove for receiving the heat pipe therein.

14. The method of claim 12, wherein the heat-absorbing member includes a vapor chamber-based heat spreader to which the LED die is directly attached, and the heat-dissipating member includes a plurality of fins thermally attached to the heat spreader.

15. The method of claim 12, further comprising a step of providing a circuit board which defines a through hole therein and placing the LED die in the through hole.

16. An LED assembly comprising:
a circuit board;
a plurality of LED dies electrically mounted on the circuit board, each having a first surface and an opposite second surface;
a heat-absorbing member thermally connecting with the first surfaces of the LED dies, wherein the heat-absorbing member has liquid therein;
a heat-dissipating member thermally connecting with the heat-absorbing member for dissipating heat from the heat-absorbing member to a surrounding atmosphere; and
a plurality of light penetrable packing layers encapsulating the second surfaces of the LED dies, respectively.

17. The LED assembly of claim 16, wherein the heat-absorbing member is a heat pipe and the heat-dissipating member is a heat sink having a plurality of fins and a groove defined in a bottom thereof, the groove receiving the heat pipe therein.

18. The LED assembly of claim 17, wherein the heat pipe has a recess defined in a bottom surface thereof, and the LED dies are received in the recess.

19. The LED assembly of claim 16, wherein the heat-absorbing member is a vapor chamber and the heat-dissipating member is a plurality of fins attached on a top surface of the vapor chamber.

20. The LED assembly of claim 19, wherein a bottom surface of the vapor chamber forms a plurality of protrusions fittingly extending through holes defined in the printed circuit board to thermally connect with the LED dies.
